(19) United States
(12) Patent Application Publication
(10) Pub. No.: US 2011/0066345 A1
(43) Pub. Date: Mar. 17, 2011

(54) Brake System

(75) Inventors: Shingo Nasu, Hitachinaka (JP); Ayumu Miyajima, Hitachinaka (JP); Toshiyuki Innami, Mito (JP); Kimio Nishino, Minami-alps (JP); Kentaro Ueno, Minami-alps (JP)

(73) Assignee: Hitachi Automotive Systems, Ltd., Hitachinaka-shi (JP)

(21) Appl. No.: 12/991,896

(22) PCT Filed: May 25, 2009
(86) PCT No.: PCT/JP2009/059499

§ 371 Date: Nov. 9, 2010

(30) Foreign Application Priority Data
Jun. 6, 2008 (JP) 2008-149686

(51) Int. Cl. B60T 8/48; B60T 11/16; B60T 8/172

(52) U.S. Cl. 701/70; 303/48; 303/152

(57) ABSTRACT

Fluctuations in a braking force and a deceleration during regenerative cooperative control are suppressed. A brake system includes a master pressure generating device 200, a wheel pressure generating device 300, and a regenerative braking device 18 that operate brake calipers 21a to 21d of respective brakes, and a brake control device 100 that control the actuators 200, 300, and 18. The brake control device 100 includes a braking force calculating unit 111 that determines a frictional braking force outputted at the brake calipers 21a to 21d and a regenerative braking force outputted by the regenerative braking device 18, and a communication control unit 112 that outputs braking force signals corresponding to the respective braking forces to the respective actuators 200, 300, and 18. The brake control device 100 controls the braking forces based on a pedal reaction force and a displacement amount of a piston that pressurizes a master cylinder.

### TECHNICAL FIELD

The present invention relates to a brake system that controls a deceleration of a vehicle by controlling an actuator that boosts a master cylinder.

### BACKGROUND ART

A known example of a brake system that performs cooperative control of a hydraulic brake and a regenerative brake includes, as described in Patent Document 1, a BBW (Brake-By-Wire) in which a brake pedal is electrically connected to an actuator.

Such a brake system includes, for example, a control device for controlling a frictional brake actuator that generates a braking force by pressurizing hydraulic oil and a regenerative brake actuator that generates a braking force by regeneration. Based on a stroke amount of a brake pedal, a vehicle speed, or the like, the control device determines a distribution of braking forces to be generated by the frictional brake actuator and the regenerative brake actuator, and outputs a control signal to each actuator.

In addition, Patent Document 2 describes an electrically-driven brake booster used in a brake mechanism of an automobile that utilizes an electrically-driven actuator as a booster.

### Patent Document 1 JP Patent Application Publication No. 2005-329740 A (2005)

### Patent Document 2 JP Patent Application Publication No. 2007-191133 A (2007)

### DISCLOSURE OF THE INVENTION

### Problems to be Solved by the Invention

The electrical connection between the brake pedal and the actuator in the brake system described in Patent Document 1 prevents an unnecessary reaction force or the like from being outputted to the brake pedal. However, the brake system according to Patent Document 1 has a higher production cost than a conventional brake system using a negative-pressure booster, and is low in reliability since the brake pedal and a mechanism for generating hydraulic pressure are electrically connected to each other.

The brake system described in Patent Document 2 features a brake pedal and a frictional brake actuator mechanically connected to each other, and adheres to a structure of a conventional brake system using a negative-pressure booster. Therefore, the brake system has a lower production cost and higher reliability than the brake system according to Patent Document 1. However, since the brake pedal and the frictional brake actuator are mechanically connected to each other in the brake system according to Patent Document 2, the brake system is susceptible to changes in hydraulic pressure of the frictional brake actuator during regenerative cooperative control and a reaction force of the brake pedal is liable to variation. Given that many drivers operate a brake pedal using a pedal depressing force, a variation in a pedal reaction force is accompanied by a fluctuation in a pedal stroke amount. In Patent Document 2, since an output of the frictional brake actuator is determined based on a pedal depressing force and an input rod displacement amount, a fluctuation in deceleration occurs. Since such fluctuations in the pedal reaction force and a deceleration are totally unrelated to the intentions of a driver, the respective fluctuations must be either reduced or suppressed.

An object of the present invention is to provide a brake control technique that enables suppression of fluctuations in deceleration not intended by a driver.

### Means for Solving the Problems

In order to achieve the object described above, a brake system according to the present invention includes a pedal and an actuator that generates hydraulic pressure, wherein the brake system controls a braking force based on a pedal reaction force.

In addition to the feature described above, the brake system according to the present invention controls braking force based on a displacement amount of a piston that pressurizes a master cylinder.

Furthermore, the brake system according to the present invention controls a braking force based on a pedal reaction force and on a hydraulic pressure generated by the actuator.

Moreover, the brake system according to the present invention includes a control device that stores braking force characteristics based on a pedal reaction force and on a displacement amount of the piston that pressurizes the master cylinder.

In addition, the brake system according to the present invention includes a control device that stores braking force characteristics based on a pedal reaction force and on a hydraulic pressure generated by the actuator.

Furthermore, the brake system according to the present invention includes: a hydraulic braking device having a pedal, a master pressure generating device, and a wheel pressure generating device; and a regenerative braking device, wherein the brake system adjusts a total braking force based on a pedal reaction force and a displacement amount of a piston that pressurizes a master cylinder in order to maintain the total braking force at approximately a constant level when a transition is made from regenerative braking to frictional braking in response to a decrease in vehicle speed.

Moreover, in addition to the features described above, the brake system according to the present invention includes: means for calculating a maximum regenerative braking force based on a vehicle speed and/or a gear position; and means for calculating a regenerative braking force limit based on a vehicle speed, wherein the regenerative braking force limit is to be set as a regenerative braking force when the maximum regenerative braking force is greater than the regenerative braking force limit, the maximum regenerative braking force is to be set as a regenerative braking force when the maximum regenerative braking force is smaller than the regenerative braking force limit, the regenerative braking device is to output the regenerative braking force and the hydraulic braking device is to output a difference between the total braking force and the regenerative braking force when the total braking force is greater than the regenerative braking force, while the total braking force is to be outputted solely by the regenerative braking device when the total braking force is smaller than the regenerative braking force.

Furthermore, an automobile according to the present invention is mounted with any of the brake systems described above.

### Advantage of the Invention

According to the present invention, since a braking force fluctuation and a deceleration fluctuation during a transition period from a regenerative brake to a hydraulic brake can be suppressed, brake operations of vehicles such as a hybrid vehicle mounted with a hydraulic brake and a regenerative brake, an electric car, and the like can be operated in a stable and simple manner.

### BRIEF DESCRIPTION OF THE DRAWINGS

FIG. 1 is an explanatory diagram illustrating a configuration of a vehicle to which the present invention has been applied.

FIG. 2 is an explanatory diagram illustrating a functional configuration of a brake system according to the present invention.

FIG. 3 is an explanatory diagram illustrating a configuration of a master pressure generating device and a wheel pressure generating device according to the present invention.

FIG. 4 is a flowchart illustrating basic operations of the brake system according to the present invention.

FIG. 5 is a graph illustrating a maximum regenerative braking force outputted by a regenerative braking device based on a vehicle speed and a gear position in the brake system according to the present invention.

FIG. 6 is a graph illustrating a limit of a regenerative braking force outputted by the regenerative braking device based on a vehicle speed in the brake system according to the present invention.

FIG. 7 is a graph illustrating a frictional braking force outputted by the master pressure generating device based on an input rod displacement amount in the brake system according to the present invention.

FIG. 8 is a graph illustrating an ideal output during execution of the flowchart illustrated in FIG. 4 when a frictional braking force and a regenerative braking device are approximately equal to each other in the brake system according to the present invention.

FIG. 9 is a graph illustrating an actual output when a master pressure generating device 200 and a regenerative braking device 18 are controlled according to the flowchart illustrated in FIG. 4 in a case where a frictional braking force and a regenerative braking device are approximately equal to each other in the brake system according to the present invention.

FIG. 10 is a graph illustrating an actual output when a wheel pressure generating device 300 and the regenerative braking device 18 are controlled according to the flowchart illustrated in FIG. 4 in a case where a frictional braking force and a regenerative braking device are approximately equal to each other in the brake system according to the present invention.

FIG. 11 is a graph illustrating characteristics of a total braking force outputted by the brake system based on a pedal reaction force and a piston displacement amount used in the brake system according to the present invention.

FIG. 12 is a flowchart illustrating operations of the brake system according to the present invention.

FIG. 13 is a graph illustrating an actual output when the master pressure generating device 200 and the regenerative braking device 18 ace controlled according to the total braking force characteristics illustrated in FIG. 11 and the flowchart illustrated in FIG. 12 in a case where a frictional braking force and a regenerative braking force are approximately equal to each other in the brake system according to the present invention.

FIG. 14 is a graph illustrating characteristics of a total braking force outputted by the brake system based on a pedal reaction force and on a hydraulic pressure increased/reduced by the wheel pressure generating device 300 used in the brake system according to the present invention.

FIG. 15 is a graph illustrating an actual output when the wheel pressure generating device 300 and the regenerative braking device 18 are controlled according to the total braking force characteristics illustrated in FIG. 14 and the flowchart illustrated in FIG. 12 in a case where the frictional braking force and a regenerative braking device are approximately equal to each other in the brake system according to the present invention.

### DESCRIPTION OF SYMBOLS

10 vehicle
15a, 15b, 15c, 15d wheel
16 brake pedal
17 electrical storage device
18 regenerative braking device
20a, 20b, 20c, 20d disk rotor
21a, 21b, 21c, 21d brake caliper
31 brake sensor
100 brake control device
110 CPU
111 braking force calculating unit
112 communication control unit
200 master pressure generating device
201 master pressure controller
210 master pressure generating mechanism
300 wheel pressure generating device
301 wheel pressure controller
310 wheel pressure generating mechanism

### BEST MODE FOR CARRYING OUT THE INVENTION

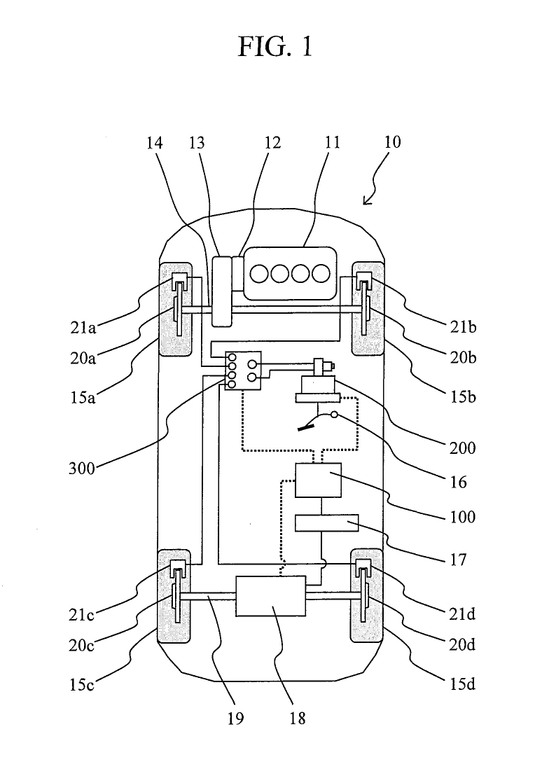

Hereinafter, an embodiment according to the present invention will be described with reference to FIGS. 1 to 15.

While the present embodiment is an example where the present invention is applied to an FF (front-engine, front-wheel drive) vehicle, the example is not restrictive and the present invention is also applicable to vehicles such as a 4WD (four-wheel drive) vehicle and an FR (front-engine, rear-wheel drive) vehicle.

As illustrated in FIG. 1, a vehicle 10 according to a first embodiment includes an engine 11, a torque converter 12, a transmission 13, drive shafts 14 and 19, wheels 15a to 15d, a brake pedal 16, disk rotors 20a to 20d, brake calipers 21a to 21d, a brake control device 100, a master pressure generating device 200 that generates hydraulic pressure for operating the brake calipers 21a to 21d, a wheel pressure generating device 300 that similarly generates hydraulic pressure for operating the brake calipers 21a to 21d, an electrical storage device 17, and a regenerative braking device 18 that applies braking force to rear wheels 15c and 15d.

The engine 11 is an internal-combustion engine that causes an explosion of an air-fuel mixture inside a combustion chamber to generate power. A movement of a piston caused by the explosion is converted into a rotational movement of a crankshaft via a con rod. The crankshaft transfers power to front wheels 15a and 15b via the torque converter 12, the transmission 13, and the drive shaft 14.

The torque converter 12 is provided between the engine 11 and the transmission 13. Through the use of a working fluid such as oil, the torque converter 12 functions as a clutch that intermittently transfers rotational torque outputted from the engine 11 to the transmission 13, and also amplifies the rotational torque before transferring the same to the transmission 13.

The transmission 13 is provided between the torque converter 12 and the drive shaft 14 and has a plurality of gears that correspond to respective shift stages of, for example, five forward stages (first to fifth speeds) and one reverse stage.

The drive shaft 14 is a rotary shaft that couples the transmission 13 to the front wheels 15a and 15b, and transfers the rotational driving force of the engine 11 to the front wheels 15a and 15b.

The brake pedal 16 is to be operated by a driver when decelerating the vehicle 10. A depressing force of the driver is transferred to the master pressure generating device 200 via the brake pedal 16. Hydraulic pressure generated at the master pressure generating device 200 is transferred to the brake calipers 21a to 21d via the wheel pressure generating device 300 and operates the brake calipers 21a to 21d. The wheel pressure generating device 300 either transfers the hydraulic pressure generated at the master pressure generating device 200 to the brake calipers 21a to 21d without modification, or transfers the hydraulic pressure to the brake calipers 21a to 21d after further pressurization.

The brake is made up of disk rotors 20a to 20d and the brake calipers 21a to 21d. The respective disk rotors 20a to 20d are fixed to the respective wheels 15a to 15d and rotate integrally with the wheels 15a to 15d. Although not shown, each of the brake calipers 21a to 21d is made up of a cylinder, a piston, a pad, and the like. The pistons in the cylinders are moved by hydraulic oil from the master pressure generating device 200 and the wheel pressure generating device 300, and press pads coupled to the pistons against the disk rotors 20a to 20d. When the pads press against the disk rotors 20a to 20d, a frictional force is generated between the pads and the disk rotors 20a to 20d. The frictional force acts as a braking force on the respective wheels 15a to 15d, and further generates a braking force between the respective wheels 15a to 15d and the road surface.

The regenerative braking device 18 is connected to drive shafts 19 respectively extending from left and right rear wheels 15c and 15d, and during a braking process, generates electricity according to a rotation of the drive shafts 19 and supplies the generated electricity to the electrical storage device 17. At the same time, rotational resistance during the generation of electricity provides a braking force to the left and right rear wheels 15c and 15d.

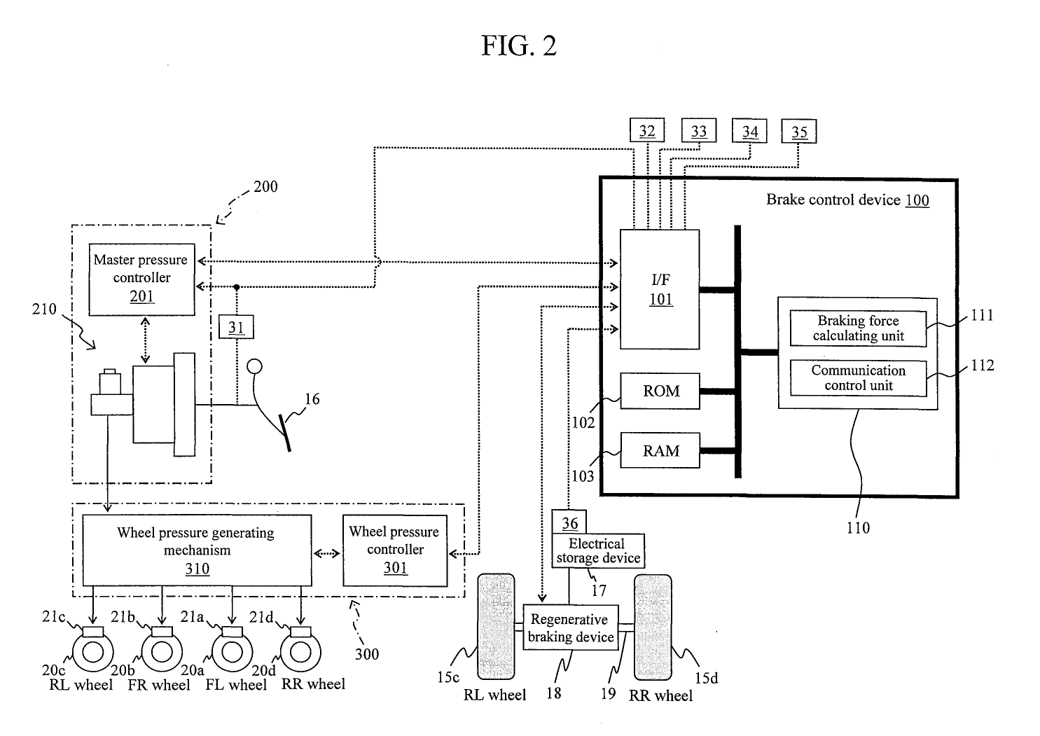

As illustrated in FIG. 2, the electrical storage device 17 is provided with a voltmeter 36 for detecting a voltage of the electrical storage device. The voltmeter 36 is connected to an interface 101 of the brake control device 100 in the same manner as other sensors.

In the present embodiment, among the components of the vehicle described above, the brake system is constituted by the brake pedal 16, the disk rotors 20a to 20d, the brake calipers 21a to 21d, the master pressure generating device 200, the wheel pressure generating device 300, the brake control device 100, a brake sensor to be described later, and the regenerative braking device 18.

As illustrated in FIG. 2, the brake control device 100 is a computer including a CPU that performs various arithmetic processing, the interface 101 that receives/transmits signals from/to the outside, a ROM 102 that stores, in advance, various programs to be executed by the CPU, various data, and the like, and a RAM 103 to be used as a workspace by the CPU.

The CPU functionally includes braking force calculating means 111 that calculates a target deceleration based on information from the various sensors, communication control means 112 that determines a braking force distribution between frictional braking and regenerative braking based on the target deceleration calculated by the braking force calculating means 111 and on information from the various sensors, and a communication control unit that controls communication with the outside. The respective functional units 111 and 112 are both activated when the CPU 110 executes programs stored in the ROM 102.

The various sensors include the brake sensor 31, a vehicle speed sensor 32 that detects a speed of the vehicle 10, a longitudinal acceleration sensor 33 that detects an acceleration being generated in a longitudinal direction of the vehicle 10, a wheel speed sensor 34 that detects speeds of the respective wheels 15a to 15d, and a gear position sensor 35 that detects a gear position of the transmission 13. The various sensors are all connected to the interface 101 of the brake control device 100.

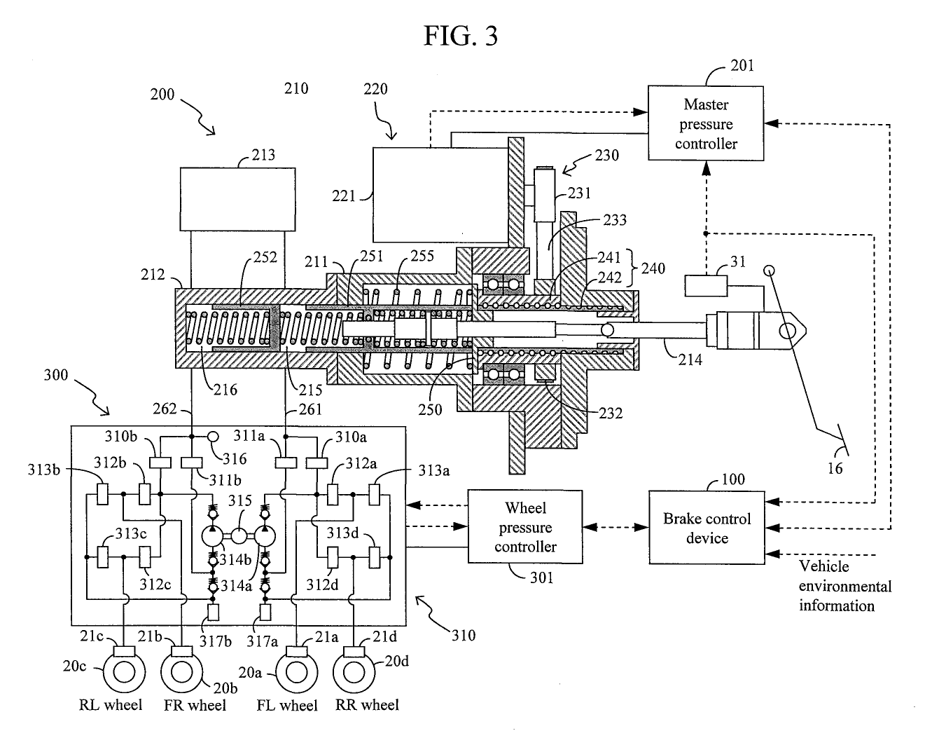

The brake sensor 31 that detects a required braking force of the driver is, as illustrated in FIG. 3, a stroke sensor that detects a displacement amount of an input rod 214 coupled to the brake pedal 16. A plurality of stroke sensors may be combined to make up the brake sensor 31. Accordingly, a fail-safe can be secured because even when a signal from one sensor ceases, a driver's brake request can be detected and recognized by the remaining sensors. In addition, the brake sensor 31 may also be a depressing force sensor that detects a depressing force applied to the brake pedal 16, or a combination of the depressing force sensor and a stroke sensor.

The master pressure generating device 200 includes a master pressure controller 201 that receives a drive control signal from the brake control device 100 and a master pressure generating mechanism 210 controlled by the master pressure controller 201.

In addition, the wheel pressure generating device 300 includes a wheel pressure controller 301 that receives a drive control signal from the brake control device 100 and a wheel pressure generating mechanism 310 controlled by the wheel pressure controller 301.

As illustrated in FIG. 3, the master pressure generating mechanism 210 includes a return spring storage cylinder 211, a master cylinder 212 internally filled with hydraulic oil, a reservoir tank 213 that stores hydraulic oil to be supplied to the inside of the master cylinder 212, the input rod 214 as first pressurizing means having one end coupled to the brake pedal 16 and another end facing the inside of the master cylinder 212, and a motor pressurizing mechanism 220 as second pressurizing means.

The inside of the reservoir tank 213 is divided by a partition wall, not shown, to provide the reservoir tank 213 with two fluid chambers. The respective fluid chambers are connected to respective fluid chambers 215 and 216, to be described later, in the master cylinder 212.

The motor pressurizing mechanism 220 includes a pressurizing motor 221 that is driven by a drive signal from the master pressure controller 201, a deceleration mechanism 230 that amplifies a rotational torque of the pressurizing motor 221, a rotation-to-translation conversion mechanism 240 that converts a rotational force into a translational force, a movable member 250 that moves linearly while in contact with the rotation-to-translation conversion mechanism 240, a primary piston 251 that is pressed by the movable member 250 and forms a primary fluid chamber 215 in the master cylinder 212, a secondary piston 252 that forms a secondary fluid chamber 216 in the master cylinder 212, and a return spring 255 which is arranged inside the return spring storage cylinder 211 and which attempts to restore the movable member 250 pressed by the rotation-to-translation conversion mechanism 240 to its original position.

The deceleration mechanism 230 amplifies a rotational torque of the pressurizing motor 221 precisely by a deceleration ratio thereof Suitable deceleration methods include gear deceleration and pulley deceleration. The present embodiment adopts a pulley deceleration system that includes a driving side pulley 231 attached to a rotational shaft of the pressurizing motor 221, a driven side pulley 232, and a belt 233 that bridges the driving side pulley 231 and the driven side pulley 232. When the pressurizing motor 221 has a sufficiently large rotational torque and does not require torque amplification by deceleration, the deceleration mechanism 230 may be omitted and the pressurizing motor 221 may be directly coupled to the rotation-to-translation conversion mechanism 240. Accordingly, various problems related to reliability, quietness, mountability, and the like that arise due to the interposition of the deceleration mechanism 230 can be avoided.

The rotation-to-translation conversion mechanism 240 converts a rotational power of the pressurizing motor 221 into a translational power and presses the primary piston 251 via the movable member 250. Suitable conversion mechanisms include a rack-and-pinion and a ball screw. The present embodiment adopts a ball screw system including a ball screw nut 241 that is rotated by the driven side pulley 232 and a ball screw shaft 242 whose translational movement is caused by a rotational movement of the ball screw nut 241.

One end of the input rod 214 is coupled to the brake pedal 16 and the other end faces the inside of the primary fluid chamber 215 in the master cylinder 212. When the brake pedal 16 is depressed and the input rod 214 makes a rectilinear movement, the hydraulic pressure in the primary fluid chamber 215 rises and the secondary piston 252 is pressed, causing the hydraulic pressure in the secondary fluid chamber 216 to also rise. As a result, hydraulic oil is supplied to a first master pipe 261 connecting the primary fluid chamber 215 and the wheel pressure generating mechanism 310 and to a second master pipe 262 connecting the secondary fluid chamber 216 and the wheel pressure generating mechanism 310, and the hydraulic oil is then delivered to the respective brake calipers 21a to 21d via the wheel pressure generating device 300. Therefore, a predetermined braking force can be secured even when the motor pressurizing mechanism 220 is unable to operate normally due to a failure or the like.

In addition, as described above, when the brake pedal 16 is depressed, the hydraulic pressure in the primary fluid chamber 215 rises and the hydraulic pressure acts as a brake pedal reaction force. Therefore, by adopting the structure of the present embodiment, a mechanism such as a screw for generating a brake pedal reaction force becomes unnecessary. Accordingly, a contribution can be made to reducing the size and weight of the brake system.

The pressurizing motor 221 is operated by a drive signal from the master pressure controller 201 and generates a desired rotational torque. While a DC motor, a DC brushless motor, an AC motor or the like is suitable as the pressurizing motor 221, a DC brushless motor is most preferable in terms of controllability, quietness, and durability. The pressurizing motor 221 includes a position sensor and is configured so that a position signal from the position sensor is inputted to the master pressure controller 201. Accordingly, the master pressure controller 201 is capable of calculating a rotational angle of the pressurizing motor 221 based on the position signal from the position sensor, and further calculating a translation amount of the rotation-to-translation conversion mechanism 240 or, in other words, a displacement amount of the primary piston 251.

The rotational torque of the pressurizing motor 221 is amplified by the deceleration mechanism 230 and rotates the ball screw nut 241 of the rotation-to-translation conversion mechanism 240. The rotation of the ball screw nut 241 causes a translational movement of the ball screw shaft 242, which in turn presses against the primary piston 251 via the movable member 250.

In addition, an end of the return spring 255 is in contact with the movable member 250 on a side opposite to the ball screw shaft 242, and the other end of the return spring 255 is in contact with an inner wall of the return spring storage cylinder 211. Therefore, a force in the opposite direction of the thrust force of the ball screw shaft 242 acts on the ball screw shaft 242 via the movable member 250. Accordingly, in a state where the pressurizing motor 221 is driven, the primary piston 251 is pressed, and a master pressure (a pressure within the master cylinder 212) is being pressurized, even if the pressurizing motor 221 stops due to a failure or the like and a return control applied to the ball screw shaft 242 is disabled, the ball screw shaft 242 is returned to its initial position by an elastic force of the return spring 255 and the master cylinder pressure can be lowered to around zero. As a result, a drag on the braking force due to a failure of the pressurizing motor 221 can be avoided.

When the primary piston 251 is pressed, the hydraulic pressure in the primary fluid chamber 215 rises, in turn pressing the secondary piston 252 and causing the hydraulic pressure in the secondary fluid chamber 216 to also rise. As a result, hydraulic oil is supplied to the first master pipe 261 connecting the primary fluid chamber 215 and the wheel pressure generating mechanism 310 and to the second master pipe 262 connecting the secondary fluid chamber 216 and the wheel pressure generating mechanism 310, and the hydraulic oil is then delivered to the respective brake calipers 21a to 21d via the wheel pressure generating device 300. In other words, hydraulic oil is delivered to the respective brake calipers 21a to 21d via the master pipes 261 and 262 and the wheel pressure generating device 300 even when the input rod 214 is pressed by the depressing force of the driver or when the primary piston 251 is pressed by the drive of the pressurizing motor 221.

The present embodiment adopts a tandem system provided with the primary piston 251 and the secondary piston 252. The reason for this is to secure a certain level of master pressure even if oil leaks from the master cylinder 212. For example, when an oil leak occurs in the primary fluid chamber 215, due to the configuration illustrated in FIG. 3, the primary piston 251 directly presses the secondary piston 252 so as to ensure that the hydraulic pressure in the secondary fluid chamber 216 rises.

In the present embodiment, by displacing the primary piston 251 according to a displacement amount of the input rod 214 resulting from a braking operation of the driver, pressurization of the hydraulic pressure in the primary fluid chamber 215 due to the input rod 214 can be further amplified. The amplification ratio (hereunder, referred to as a “boosting ratio”) is determined by a ratio of a displacement amount of the input rod 214 to that of the primary piston 251, a ratio of a cross-sectional area of the input rod 214 (hereunder, referred to as “AIR”) to that of the primary piston 251 (hereunder, referred to as “APP”), or the like. In particular, when displacing the primary piston 251 by the same amount as the displacement amount of the input rod 214, the boosting ratio is uniquely determined as (AIR+APP)/AIR. More specifically, by setting AIR and APP based on a necessary boosting ratio and controlling the primary piston 60 so that the displacement amount thereof becomes equal to the displacement amount of the input rod 214, a constant boosting ratio can always be obtained. A displacement amount of the input rod 214 is detected by the brake sensor 31 and a displacement amount of the primary piston 251 is calculated by the master pressure controller 201 based on a signal from a position sensor of the pressurizing motor 221.

The wheel pressure generating mechanism 310 includes outlet gate valves 310a and 310b that control the supply of hydraulic oil from the master pressure generating mechanism 210 to the respective brake calipers 21a to 21d, inlet gate valves 311a and 311b that control the supply of hydraulic oil from the master pressure generating mechanism 210 to pumps, to be described later, inlet valves 312a to 312d that control the supply of hydraulic oil having passed through the outlet gate valves 310a and 310b and hydraulic oil from the pumps to the respective brake calipers 21a to 21d, outlet valves 313a to 313d that control pressure reduction of the hydraulic pressure on the brake calipers 21a to 21d, pumps 314a and 314b that boost hydraulic oil supplied from the master pressure generating mechanism 210 via the inlet gate valves 311a and 311b, a pump motor 315 that drives the pumps 314a and 314b, a master pressure sensor 316 that detects a master pressure, and reservoir tanks 317a and 317b.

A hydraulic pressure control unit for anti-lock brake control, a hydraulic pressure control unit for vehicle behavior stabilization control, a hydraulic pressure control unit for brake-by-wire, or the like can be adopted as the wheel pressure generating mechanism 310 described above.

The wheel pressure generating mechanism 310 is constituted by two systems, namely, a first brake system that controls the supply of hydraulic pressure to the FL (front left) wheel brake caliper 21a and the RR (rear right) wheel brake caliper 21d, and a second brake system that controls the supply of hydraulic pressure to the FR (front right) wheel brake caliper 21b and the RL (rear left) wheel brake caliper 21c.

The first brake system is made up of the outlet gate valve 310a, the inlet gate valve 311a, the inlet valves 312a and 312d, the outlet valves 313a and 313d, and the reservoir tank 317a. In addition, the second brake system is made up of the outlet gate valve 310b, the inlet gate valve 311b, the inlet valves 312b and 312c, the outlet valves 313b and 313c, and the reservoir tank 317b. The first master pipe 261 connected to the primary fluid chamber 215 of the master pressure generator 210 is connected to the outlet gate valve 310a and the inlet gate valve 311a of the first brake system, and the second master pipe 262 connected to the secondary fluid chamber 216 of the master pressure generator 210 is connected to the outlet gate valve 310b and the inlet gate valve 311b of the second brake system.

By providing two brake systems in this manner, even if one of the brake systems fails, a braking force of two wheels at diagonally opposing corners can be secured by the other normally-operating brake system and the behavior of the vehicle can be kept stable.

The outlet gate valves 310a and 310b, the inlet gate valves 311a and 311b, the inlet valves 312a to 312d, and the outlet valves 313a to 313d are all electromagnetic valves which include a solenoid and which are opened and closed by passing a current to the solenoid. The opening/closing of each valve is controlled by the wheel pressure controller 301. The outlet gate valves 310a and 310b and the inlet valves 312a to 312d are valves that enter an open state when currents to the valves are interrupted and enter a closed state when the currents flow through the valves, while the inlet gate valves 311a and 311b and the outlet valves 313a to 313d are valves that enter a closed state when currents to the valves are interrupted and enter an open state when the currents flow through the valves.

While a plunger pump, a trochoid pump, a gear pump or the like is suitable as the pumps 314a and 314b, a gear pump is most desirable in terms of quietness. The pump motor 315 is operated by a drive signal from the wheel pressure controller 301 and drives the pumps 314a and 314b that are coupled to the pump motor 315. While a DC motor, a DC brushless motor, an AC motor or the like is suitable as the pump motor 315, a DC brushless motor is most desirable in terms of controllability, quietness, and durability.

The master pressure sensor 316 is connected to the second master pipe 262 connected to the secondary fluid chamber 216 of the master pressure generating mechanism 210. A master pressure detected by the master pressure sensor 316 is sent to the wheel pressure controller 301. Moreover, the number of master pressure sensors 316 and installation positions thereof are to be appropriately determined from the perspectives of controllability, fail-safe, and the like.

Next, operations of the wheel pressure generating mechanism 310 will be described. Hereinafter, only operations of the first brake system will be described. Since operations of the second brake system are the same as the operations of the first brake system, a description thereof will be omitted.

First, a case will be described where a hydraulic pressure boosted by the master pressure generating mechanism 210 is supplied as-is to the FL wheel brake caliper 21a and the RR wheel brake caliper 21d without further boosting. In this case, the inlet gate valve 311a and the outlet valves 313a and 313d are in a closed state, and the outlet gate valve 310a and the inlet valves 312a and 312d are in an open state.

Hydraulic oil from the master pressure generating mechanism 210 via the first master pipe 261 is sent to the brake calipers 21a and 21d via the outlet gate valve 310a and the inlet valves 312a and 312d. In other words, hydraulic oil from the master pressure generating mechanism 210 is supplied to the brake calipers 21a and 21d without being boosted by the pump 314a.

As described above, the outlet gate valves 310a and 310b and the inlet valves 312a to 312d enter an open state when currents to the valves are interrupted, while the inlet gate valves 311a and 311b and the outlet valves 313a to 313d enter a closed state when currents to the valves are interrupted in the present embodiment. The states of the respective valves during the current interruption are the same as the states of the respective valves when hydraulic oil from the master pressure generating mechanism 210 is supplied as-is to the brake calipers 21a and 21d without being boosted by the pump 314a. Therefore, hydraulic oil can be supplied from the master pressure generating mechanism 210 to the brake calipers 21a and 21d even when the power supply system fails and currents cannot be supplied to the respective valves. In other words, even in the event of failure of the wheel pressure generating mechanism 310, pressure of the hydraulic oil sent to the brake calipers 21a and 21d can be controlled by the master pressure generating mechanism 210.

Next, a case will be described where hydraulic pressure boosted by the master pressure generating mechanism 210 is supplied to the FL wheel brake caliper 21a and the RR wheel brake caliper 21d after subjected to further boosting by the pump 314a. In this case, the inlet gate valve 311a and the inlet valves 312a and 312d are in an open state, and the outlet gate valve 310a and the outlet valves 313a and 313d are in a closed state.

Hydraulic oil supplied from the master pressure generating mechanism 210 via the first master pipe 261 is sent to the pump 314a via the inlet gate valve 311a to be boosted. The hydraulic oil boosted by the pump 314a is sent to the brake calipers 21a and 21d via the inlet valves 312a and 312d. Moreover, hydraulic oil can be sent from the pump 314a to the brake calipers 21a and 21d even when the master pressure generating mechanism 210 fails and hydraulic oil cannot be supplied from the master pressure generating mechanism 210. In this case, the inlet gate valve 311a and the outlet gate valve 310a enter a closed state.

As described above, the present embodiment adopts a configuration wherein even if one of the master pressure generating device 200 and the wheel pressure generating device 300 becomes defective, output from the other is not prevented.

Next, a case will be described where a hydraulic pressure applied to the brake calipers 21a and 21d is reduced. In this case, while the outlet valves 313a and 313d are in an open state and the other valves are either in an open or closed state as situations demand, the inlet valves 312a and 312d are basically in a closed state.

Hydraulic oil retained in the brake calipers 21a and 21d flows into the reservoir tank 317a respectively via the outlet valves 313a and 313d. The hydraulic oil in the reservoir tank 317a is to be used when boosting the hydraulic oil from the master pressure generating mechanism 210 at the pump 314a.

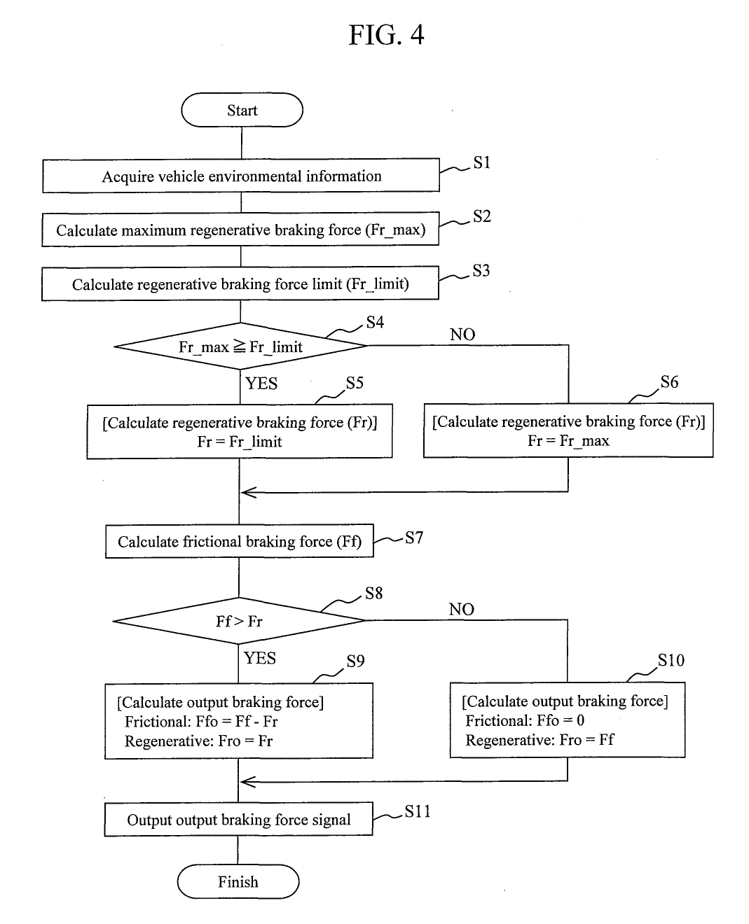

Operations of the brake control device 100 will now be described according to the flowchart illustrated in FIG. 4.

In step S1, the communication control unit 112 of the brake control device 100 acquires, at predetermined time intervals, various vehicle environmental information from the respective sensors and the like, and stores the information in the RAM 103. In this case, the predetermined time interval is set to a millisecond. The respective sensors and the like include, in addition to the aforementioned brake sensor 31, the vehicle speed sensor 32, the longitudinal acceleration sensor 33, the wheel speed sensor 34, the gear position sensor 35, and the voltmeter 36, the master pressure controller 201 and the wheel pressure controller 301. Basically, the respective sensors 31 to 36 constantly output detected values when the ignition is turned on, and the interface 101 receives output from the respective sensors 31 to 36 at predetermined time intervals. In addition, basically, the master pressure controller 201 constantly detects a hydraulic pressure inside the master cylinder and a displacement amount of the primary piston 251 when the ignition is turned on, and the interface 101 receives the values of fluid pressure and the displacement amount. Moreover, various vehicle environmental information from the respective sensors 31 to 36 acquired over a predetermined number of times is stored in the RAM 103 in order to recognize changes in vehicle environmental information.

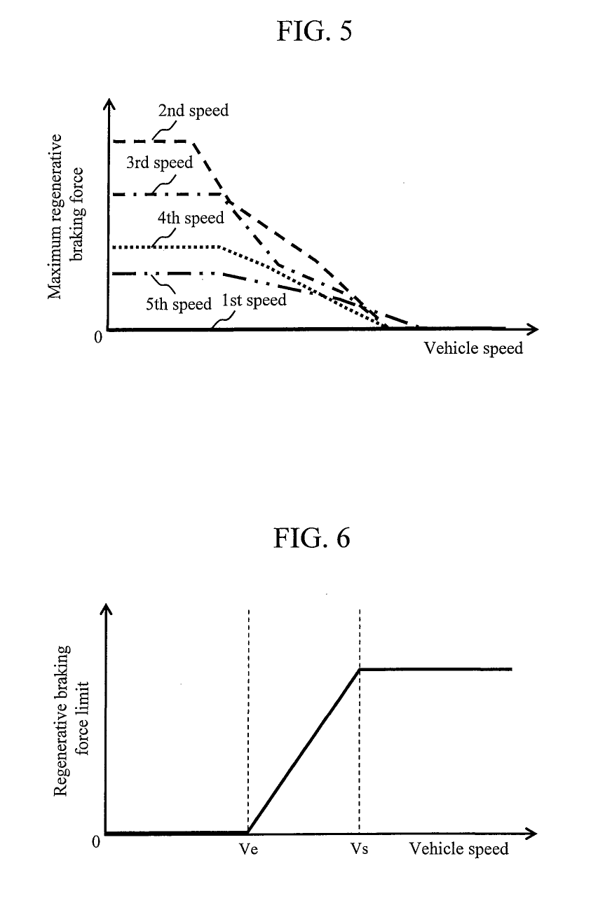

Next, in step S2, the braking force calculating unit 111 calculates a maximum regenerative braking force Fr_max based on a vehicle speed and a gear position acquired in step S1. The maximum regenerative braking force is the greatest regenerative braking force that can be generated by the regenerative braking device 18 and is determined based on a vehicle speed and a gear position. Methods of determining the maximum regenerative braking force include storing table data illustrated in FIG. 5 in the ROM 102 in advance and referencing the table data.

Next, in step S3, a regenerative braking force limit Fr_limit is calculated based on the vehicle speed acquired in step S1. A power generating efficiency of the regenerative braking device 18 declines significantly as the wheels 15c and 15d slow down. Therefore, a regenerative braking force is limited at or below a vehicle speed where the power generating efficiency declines.

Methods of determining the regenerative braking force limit Fr_limit include storing table data illustrated in FIG. 6 in the ROM 102 in advance and referencing the table data. FIG. 6 illustrates that the regenerative braking force limit is gradually lowered from a vehicle speed Vs to a vehicle speed Ve and is set to 0 at the vehicle speed Ve. The period from the vehicle speed Vs to the vehicle speed Ve is a period where a switchover occurs from a regenerative braking force to a frictional braking force, to be described later. Moreover, the vehicle speed Vs and the vehicle speed Ve are determined based on the performance of the regenerative braking device 18.

In addition, the regenerative braking force Fr_limit is set to 0 regardless of a vehicle speed V when a voltage value indicated on the voltmeter 36 reaches a predetermined voltage value or, in other words, when the amount of electricity stored in the electrical storage device 17 reaches a predetermined amount because power generated by the regenerative braking device 18 can no longer be stored. However, depending on the type of the electrical storage device 17, the method described above cause may shorten the life span of the electrical storage device 17. Therefore, a method may alternatively be adopted in which the regenerative braking force Fr_limit is gradually reduced to 0 from a predetermined stored electricity amount.

Next, in step S4, the sizes of the maximum regenerative braking force Fr_max and the regenerative braking force limit Fr_limit are compared. When the maximum regenerative braking force Fr_max is equal to or greater than the regenerative braking force limit Fr_limit, in step S5, Fr_limit is substituted into the regenerative braking force Fr so that a braking force equal to or under the regenerative braking force limit is outputted. When the maximum regenerative braking force Fr_max is lower than the regenerative braking force limit Fr_limit, in step S6, Fr_max is substituted into the regenerative braking force Fr because the maximum regenerative braking force is equal to or lower than the regenerative braking force limit.

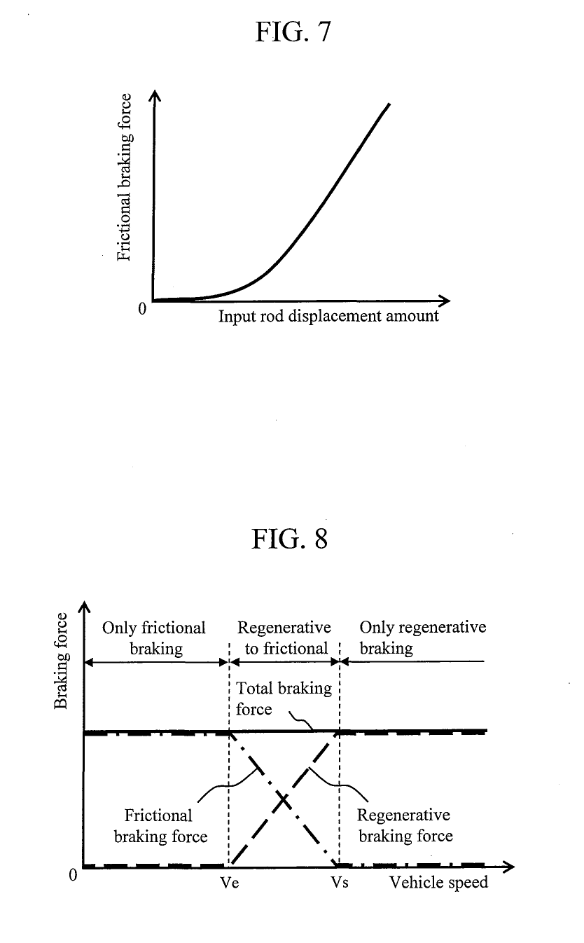

Next, in step S7, a frictional braking force Ff is calculated based on the displacement amount of the input rod 214 acquired in step S1. The frictional braking force is a braking force that acts on the respective wheels 15a to 15d when the master pressure generating device 200 and the wheel pressure generating device 300 are in operation. Methods of determining a frictional braking force include storing table data illustrated in FIG. 7 in the ROM 102 in advance and referencing the table data. FIG. 7 illustrates characteristics measured on a dry asphalt road (road surface μ=0.9).

Next, in step S8, the sizes of the frictional braking force Ff and the regenerative braking force Fr are compared. When the frictional braking force Ff is greater than the regenerative braking force Fr, the braking force (frictional braking force) required by the driver surpasses the regenerative braking force. Therefore, in step S9, Ff-Fr is substituted into a frictional braking force output command value Ffo to be transmitted to the master pressure controller 201 and the wheel pressure controller 301 while Fr is substituted into a regenerative braking force output value Fro to be transmitted to the regenerative braking device 18.

When the frictional braking force Ff is equal to or smaller than the regenerative braking force Fr, since a braking force equivalent to the frictional braking force Ff can be outputted by the regenerative braking force Fr alone, in step S10, 0 is substituted into the frictional braking force output command value Ffo and Ff is substituted into the regenerative braking force output value Fro. Subsequently, in step S11, the communication control unit 112 outputs a braking force signal corresponding to a present braking force to the master pressure generating device 200, the wheel pressure generating device 300, and the regenerative braking device 18.

The frictional braking force Ffo is outputted to the master pressure generating device 200 or the wheel pressure generating device 300 but basically to the master pressure generating device 200. The regenerative braking force Fro is outputted to the regenerative braking device 18.

Hereinafter, a case will be described where the frictional braking force Ffo is outputted to the master pressure generating device 200 and the regenerative braking force Fro is outputted to the regenerative braking device 18.

An execution of the flowchart illustrated in FIG. 4 results in, for example, the output illustrated in FIG. 8. FIG. 8 illustrates an output in a case where the sizes of a frictional braking force and a regenerative braking force are equal to each other and an input rod displacement amount does not fluctuate. From a vehicle speed Vs to a vehicle speed Ve, the regenerative braking force decreases as the regenerative braking force limit drops while the frictional braking force increases so as to compensate for the decline in the regenerative braking force. In the case illustrated in FIG. 8, since the input rod displacement amount or, in other words, the command value does not fluctuate, a total braking force combining the frictional braking force and the regenerative braking force is constant in all areas.

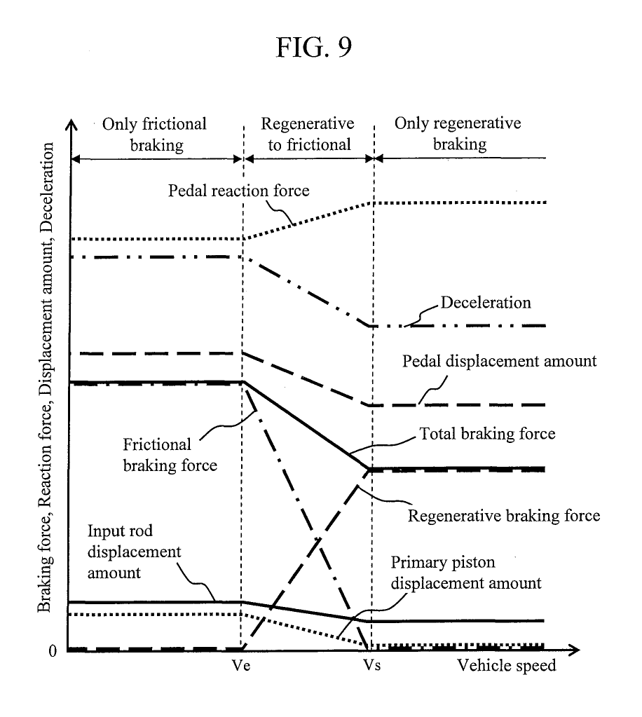

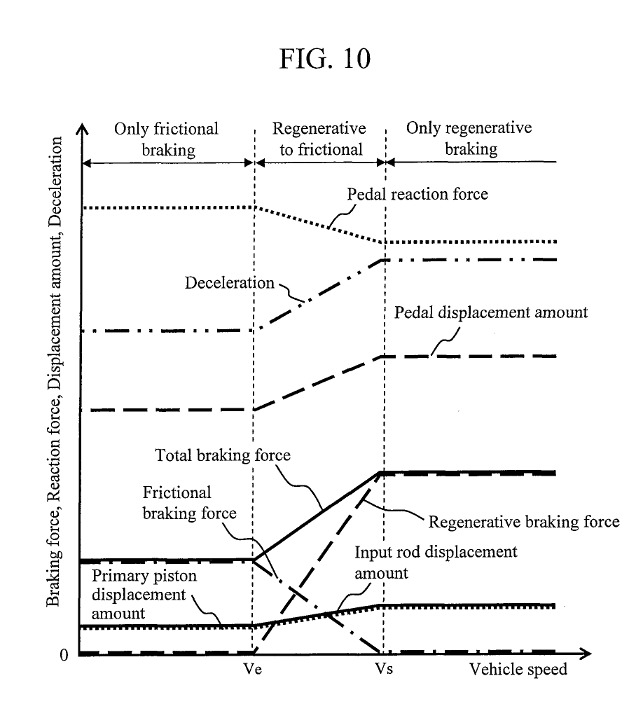

However, in reality, fluctuations such as those illustrated in FIGS. 9 and 10 occur when controlling the master pressure generating device 200 and the regenerative braking device 18 or the wheel pressure generating device 300 and the regenerative braking device 18 according to the flowchart illustrated in FIG. 4. FIG. 9 illustrates a result of controlling the master pressure generating device 200 and the regenerative braking device 18 according to the flowchart illustrated in FIG. 4, and FIG. 10 illustrates a result of controlling the wheel pressure generating device 300 and the regenerative braking device 18 according to the flowchart illustrated in FIG. 4. Such fluctuations are caused by a fluctuation in a reaction force of the brake pedal that accompanies fluctuations in a hydraulic pressure in the master cylinder that is generated when generating a frictional braking force, a spring reaction force, or a sliding resistance.

The examples illustrated in FIGS. 9 and 10 are both cases where the brake pedal is depressed at a constant depressing force. In the example illustrated in FIG. 9, during the switchover from regenerative braking to frictional braking, the pedal reaction force declines, a pedal displacement amount increases, an input rod displacement amount increases, and a frictional braking force command value increases. As a result, fluctuations occur in the total braking force and the deceleration.

In addition, in the example illustrated in FIG. 10, during the switchover from regenerative braking to frictional braking, a pedal reaction force increases, a pedal displacement amount decreases, an input rod displacement amount decreases, and a frictional braking force command value decreases. As a result, fluctuations occur in the total braking force and the deceleration.

A method of addressing the problem described above by controlling the master pressure generating device 200 and the regenerative braking device 18 will now be described.

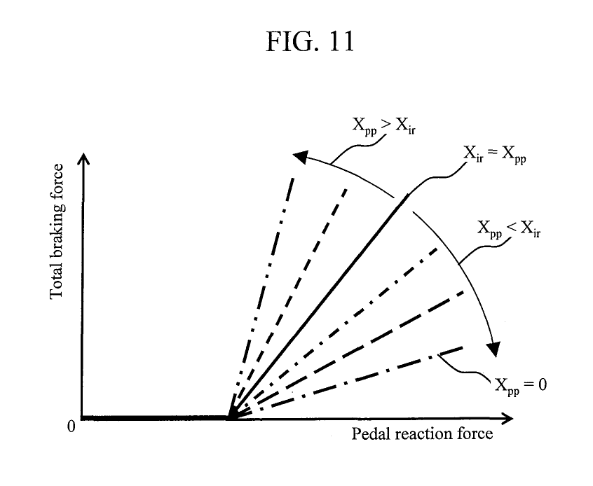

First, for example, one method involves determining a total braking force that is a sum of a frictional braking force and a regenerative braking force from the pedal reaction force illustrated in FIG. 11 based on a relationship between an input rod displacement amount Xir and a primary piston displacement amount Xpp. The method takes into consideration fluctuations in a pedal reaction force and a primary piston displacement amount during a switchover period from regenerative braking to frictional braking. While a change in characteristics in which the total braking force increases occurs when the primary piston is displaced so as to output a frictional braking force, such a displacement of the primary piston causes a decrease in the pedal reaction force and reduces the total braking force.

Consequently, for example, when the regenerative braking force is approximately equal to the total braking force during regenerative braking, the total braking force does not fluctuate despite fluctuations in the primary piston displacement and the pedal reaction force after the switchover period from regenerative braking to frictional braking. As a result, a fluctuation in deceleration can be suppressed. Moreover, while a total braking force is determined using the table illustrated in FIG. 11 in the present embodiment, methods of determining a total braking force is not limited thereto and may alternatively be determined using a mathematical expression.

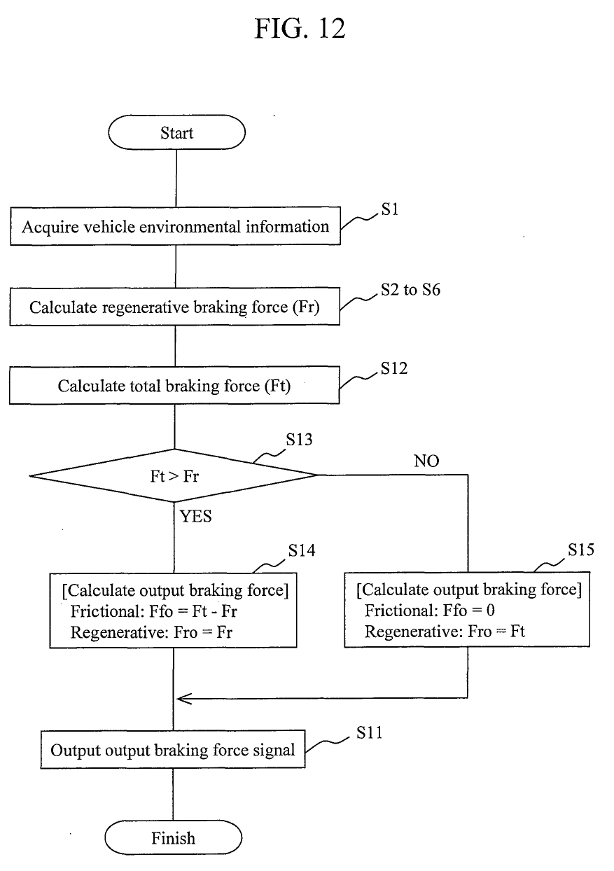

Next, operations of the brake control device 100 using the total braking force characteristics illustrated in FIG. 11 will now be described according to a flowchart illustrated in FIG. 12.

In the flowchart illustrated in FIG. 12, operations in steps S1 to S6 and S11 are basically the same as in the flowchart illustrated in FIG. 4.

In step S12, a total braking force Ft that is a braking force of the entire system and that combines a frictional braking force and a regenerative braking force is determined.

Methods of determining the total braking force Ft include storing table data illustrated in FIG. 11 in the ROM 102 in advance and referencing the table data.

FIG. 11 illustrates a total braking force to be outputted with respect to a pedal reaction force. A plurality of characteristics exists depending on a relationship between the input rod displacement amount Xir and the primary piston displacement amount Xpp. In the same manner as in the first embodiment, since a pedal reaction force varies depending on a hydraulic pressure in the master cylinder, a spring reaction force, a sliding resistance, or the like, a pedal reaction force can be determined from F=P·Air+Fk+Fo, where P denotes a hydraulic pressure inside the master cylinder, Air denotes a cross-sectional area of the input rod, Fk denotes a spring reaction force, and Fo denotes a reaction force such as a sliding resistance. The cross-sectional area of the input rod Air, the spring reaction force Fk, and the reaction force such as a sliding resistance Fo are all determined according to a specification of the brake system. In addition, during frictional braking where regenerative braking is not used, a characteristic of Xir=Xpp in which the input rod displacement amount Xir and the primary piston displacement amount Xpp are approximately equal to each other is used as an initial characteristic so that a boosting ratio of a hydraulic pressure generated by displacements of the input rod and the primary piston is always constant. The relationship illustrated in FIG. 11 is a characteristic measured on a dry asphalt road (road surface μ=0.9).

Next, in step S13 in the flowchart illustrated in FIG. 12, the sizes of the total braking force Ft and the regenerative braking force Fr are compared. When the total braking force Ft is greater than the regenerative braking force Fr, a braking force that cannot be outputted by a regenerative braking force must be outputted by a frictional braking force. Therefore, in step S14, Ft-Fr is substituted into a frictional braking force output command value Ffo to be transmitted to the master pressure controller 201, and Fr is substituted into a regenerative braking force output value Fro to be transmitted to the regenerative braking device 18.

Conversely, when the total braking force Ft is equal to or smaller than the regenerative braking force Fr, since a braking force equivalent to the total braking force Ft can be outputted by the regenerative braking force Fr alone, in step S15, 0 is substituted into the frictional braking force output command value Ffo and Ft is substituted into the regenerative braking force output value Fro.

In a case where the master pressure generating device 200 and the regenerative braking device 18 are controlled according to the total braking force characteristics illustrated in FIG. 11 and to the flowchart illustrated in FIG. 12, for example, while an initially selected characteristic among FIG. 11 in step S12 in which a total braking force is determined when a regenerative braking force and a total braking force are approximately equal to each other during regenerative braking is the aforementioned characteristic expressed as Xir=Xpp, since the frictional braking force must be set to 0 when the regenerative braking force is greater than the total braking force, Xpp inevitably becomes smaller than Xir. As such, when the regenerative braking force and the total braking force are approximately equal to each other during regenerative braking as is the case with the present example, a characteristic expressed as Xpp=0 is to be selected.

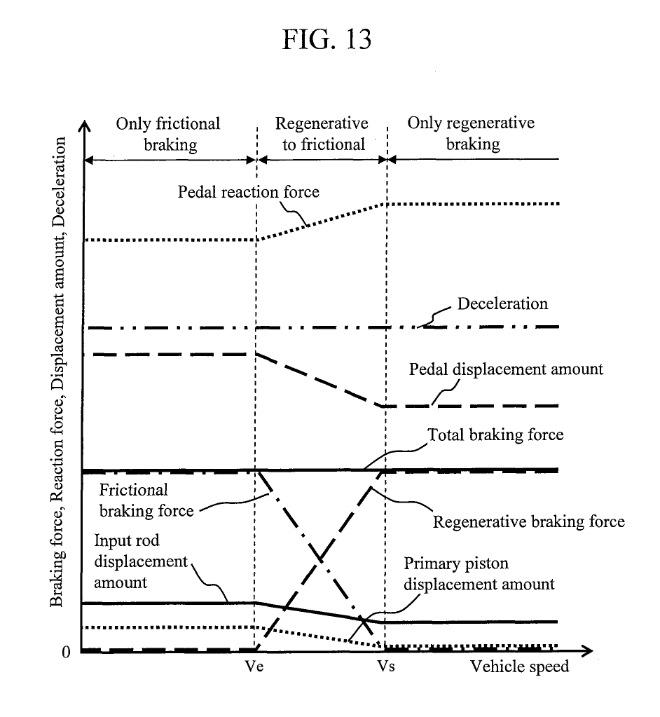

When entering the switchover period from regenerative braking to frictional braking, since the regenerative braking force becomes smaller than the total braking force and a frictional braking force must be generated, Xpp becomes greater than 0 and a characteristic that is closer to Xir=Xpp than to Xpp=0 is used. At this point, although the total braking force increases in a case where a pedal reaction force does not change, since the pedal reaction force decreases in the present brake system, the total braking force remains unchanged before and after the switchover period from regenerative braking to frictional braking and, as a result, fluctuations in the deceleration can be suppressed as illustrated in FIG. 13.

Next, as another method of suppressing fluctuations in a total braking force and a deceleration as illustrated in FIG. 10, a method of controlling the wheel pressure generating device 300 and the regenerative braking device 18 will be described.

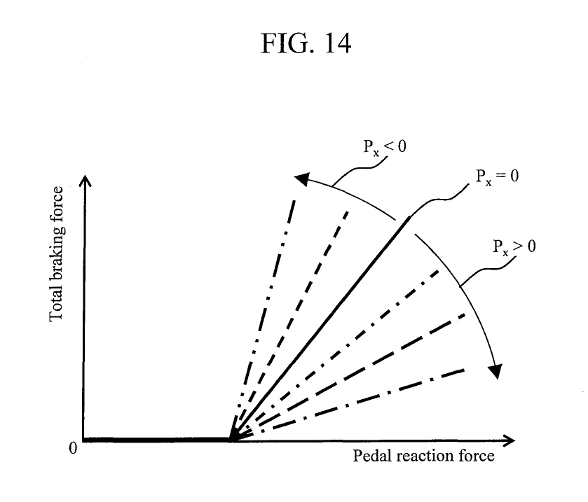

When controlling the wheel pressure generating device 300, for example, one method involves determining a total braking force that is a sum of a frictional braking force and a regenerative braking force from the pedal reaction force illustrated in FIG. 14 based on a hydraulic pressure Px that is increased or decreased by the wheel pressure generating device 300. The method takes into consideration fluctuations in the pedal reaction force and the hydraulic pressure Px that is increased or decreased by the wheel pressure generating device 300 during the switchover period from regenerative braking to frictional braking. While a change to characteristics in which the total braking force decreases occurs when the wheel pressure generating device 300 increases pressure in order to output a frictional braking force, such an increase in pressure by the wheel pressure generating device 300 causes an increase in the pedal reaction force, resulting in an increase total braking force.

Consequently, for example, when the regenerative braking force is approximately equal to the total braking force during regenerative braking, the total braking force does not fluctuate despite fluctuations in the hydraulic pressure that is increased or decreased by the wheel pressure generating device 300 or in the pedal reaction force after the switchover period from regenerative braking to frictional braking. As a result, a fluctuation in deceleration can be suppressed. Moreover, while a total braking force is determined using the table illustrated in FIG. 14 in the present embodiment, methods of determining the total braking force is not limited to such tables and may alternatively be determined using a mathematical expression.

Moreover, the method of controlling the wheel pressure generating device 300 only differs from the method of controlling the master pressure generating device 200 in the manner in which a total braking force is determined, and otherwise basically follows the flowchart illustrated in FIG. 12.

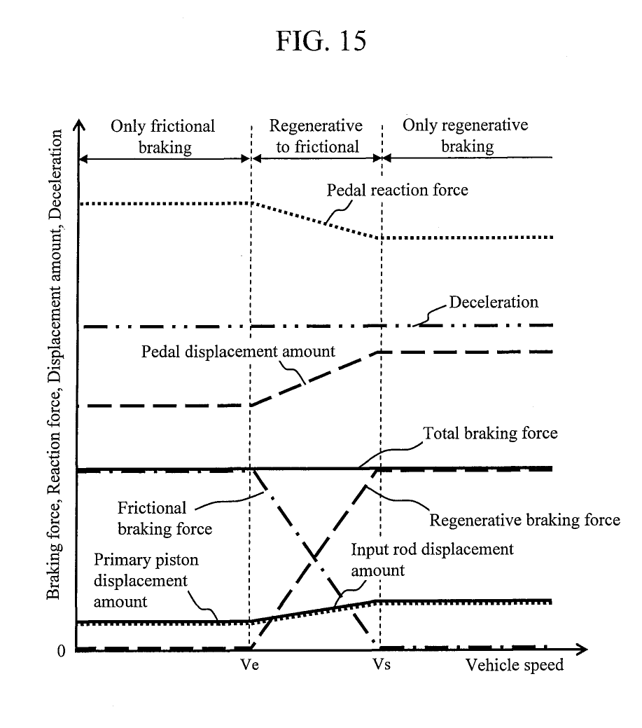

By controlling the wheel pressure generating device 300 and the regenerative braking device 18 using the total braking force characteristics illustrated in FIG. 14 according to the flowchart illustrated in FIG. 12, fluctuations in a total braking force and a deceleration can be suppressed even when a pedal reaction force fluctuates as illustrated in FIG. 15.

While an apparatus for generating a braking force is made up of the master pressure generating device 200, the wheel pressure generating device 300, and the regenerative braking device 18 in the present embodiment, the master pressure generating device 200 may be a negative pressure booster that utilizes a negative pressure of the engine 11, and the wheel pressure generating device 300 may simply be a hydraulic pipe or an ABS (anti-lock brake system) that prevents locking of wheels.

1. A brake system comprising a pedal and an actuator that generates hydraulic pressure, wherein the brake system controls a braking force based on a pedal reaction force.

2. The brake system according to claim 1, wherein the brake system controls the braking force based on a pedal reaction force and on a displacement amount of a piston that pressurizes a master cylinder.

3. The brake system according to claim 1, wherein the brake system controls the braking force based on a pedal reaction force and on a hydraulic pressure generated by the actuator.

4. The brake system according to claim 2, further comprising a control device that stores braking force characteristics based on a pedal reaction force and on a displacement amount of the piston that pressurizes the master cylinder.

5. The brake system according to claim 3, further comprising a control device that stores braking force characteristics based on a pedal reaction force and on a hydraulic pressure generated by the actuator.

6. A brake system comprising: a hydraulic braking device having a pedal, a master pressure generating device, and a wheel pressure generating device; and a regenerative braking device, wherein
the brake system adjusts a total braking force based on a pedal reaction force and a displacement amount of a piston that pressurizes a master cylinder in order to maintain the total braking force at approximately a constant level when a transition is made from regenerative braking to frictional braking in response to a decrease in vehicle speed.

7. The brake system according to claim 6, further comprising:
means for calculating a maximum regenerative braking force based on a vehicle speed and/or a gear position; and means for calculating a regenerative braking force limit based on a vehicle speed, wherein
the regenerative braking force limit is to be set as a regenerative braking force when the maximum regenerative braking force is greater than the regenerative braking force limit, and the maximum regenerative braking force is to be set as a regenerative braking force when the maximum regenerative braking force is smaller than the regenerative braking force limit,
and the regenerative braking device is to output the regenerative braking force and the frictional braking device is to output a difference between the total braking force and the regenerative braking force when the total braking force is greater than the regenerative braking force, while the total braking force is to be outputted solely by the regenerative braking device when the total braking force is smaller than the regenerative braking force.

8. An automobile mounted with the brake system according to claim 1.

9. An automobile mounted with the brake system according to claim 6.
